(19) United States
(12) Patent Application Publication
(10) Pub. No.: US 2013/0065058 A1
(43) Pub. Date: Mar. 14, 2013

(54) EPOXY GLOW COAT

(71) Applicants: Francis Roland Gammell, Singapore (SG); Changxiong Wang, Singapore (SG)

(72) Inventors: Francis Roland Gammell, Singapore (SG); Changxiong Wang, Singapore (SG)

(73) Assignee: SINGAPORE TECHNOLOGIES AEROSPACE LTD., Singapore (SG)

(21) Appl. No.: 13/591,885

(22) Filed: Aug. 22, 2012

(30) Foreign Application Priority Data
Sep. 13, 2011 (SG) 201106585-1

(51) Int. Cl. C09K 11/08; B32B 27/38; B32B 37/14; C09K 11/80; B05D 5/06

(52) U.S. Cl. 428/413; 252/301.36; 427/157; 156/67

(57) ABSTRACT

An epoxy glow coat and a method preparing an epoxy glow coat are disclosed. The epoxy glow coat comprises a mixture obtained by mixing predefined proportions of a clear epoxy and glow powder. The method comprises the steps of: mixing a predefined proportion of a clear epoxy and glow powder to obtain a viscous mixture; applying the viscous mixture on to a desired area; and curing the mixture.

### FIELD OF INVENTION

The present invention relates to an epoxy glow coat.

### BACKGROUND

For example, a door knob made of a phosphorescent material can be used in homes to provide visual cues for accessing a door under darkness. Likewise, the arms or dial of a clock or watch can be applied with a phosphorescent material to see the time under darkness. Similarly, parts of a toy can be made of a phosphorescent material in order to access or watch a toy under darkness. Phosphorescent materials can also be used in emergency exits, helmets, rifle sights etc.

In military, visual cues are important for commandos during night missions. For example, when using a rappelling kit during night missions, in order to provide visual cues to commandos, certain areas of the rappelling kit are coated with a phosphorescent material.

Commonly used phosphorescent materials include glow paint, glow tape or glow plastic.

Using glow paint on an article e.g. a rappelling kit exposes the glow paint to wear and tear. Wear and tear may be due to physical damage from installation and removal of the article or parts of the article surrounding the area of application of the glow paint. Wear and tear can also occur when the article or parts of the article surrounding the area of application of the glow paint are exposed to chemicals, such as grease, lubricating oil, hydraulic fluid, water etc. As a result, the glow paint peels off from the article.

Using a glow tape on an article e.g. a rappelling kit exposes the glow tape to wear and tear. Wear and tear may be due to physical damage from installation and removal of the article or parts of the article surrounding the area of application of the glow tape. Wear and tear can also occur when the article or parts of the article surrounding the area of application of the glow tape are exposed to chemicals, such as grease, lubricating oil, hydraulic fluid, water etc. As a result, the glow tape peels off from the article.

Thus, repair, replacement of the relevant part, frequent re-application of the glow paint or glow tape is needed translating to increased cost and down-times of e.g. a rappelling kit.

Glow plastic is only available in a resin form which must be heated to about 200-300° C. before moulding. Moulding requires special equipments and therefore glow plastic is not typically suitable for use at room temperature.

Furthermore, the luminous intensity of glow paint or glow tape is generally low and therefore they are not suitable for fabricating articles or application on articles used e.g. in night missions. Luminous intensity here refers to the level of brightness detected by the naked eye or the luminance detected by a lux meter.

There is thus a need to provide a glow coat that seeks to address one or more of the above disadvantages.

### SUMMARY

According to a first aspect, there is provided a method of preparing an epoxy glow coat comprising the steps of: mixing a predefined proportion of a clear epoxy and glow powder to obtain a viscous mixture; applying the viscous mixture on to a desired area; and curing the mixture. The mixture may be obtained at room a temperature.

The epoxy may be Devcon 2 Ton Clear Epoxy (2 in 1). The Devcon 2 Ton Clear Epoxy (2 in 1) epoxy may comprise an Epoxide (resin) and polyamide (hardener). The resin may be Epichlorohydrin and the hardener may be Bisphenol A.

The glow powder may comprise an Alkaline Earth-Metal Aluminate Oxide doped with Europium and has a chemical formula MO.Al₂O₃:EU.

The proportion may be about 5 ml of the epoxy in about 5 g of glow powder. The proportion of glow powder (in grams) to the epoxy (ml) may be about (0.8-1.2):1.

The method may further comprise the step of applying a plurality of layers of the mixture after the curing step to obtain a glow coat with a predefined thickness.

The viscosity of the epoxy glow coat may range between about 10-20 Pa·s. The viscous mixture may be applied directly to an article, or pre-formed from a mould.

According to a second aspect, there is provided an article comprising an epoxy glow coat prepared in accordance with the above method.

According to a third aspect, there is provided an epoxy glow coat comprising: a mixture obtained by mixing predefined proportions of a clear epoxy and glow powder. The mixture may obtained at room temperature.

The epoxy may be Devcon 2 Ton Clear Epoxy (2 in 1). The Devcon 2 Ton Clear Epoxy (2 in 1) epoxy may comprise an Epoxide (resin) and polyamide (hardener). The resin may be Epichlorohydrin and the hardener may be Bisphenol A.

The glow powder may comprises an Alkaline Earth-Metal Aluminate Oxide doped with Europium and has a chemical formula MO.Al₂O₃:EU.

The proportion may be about 5 ml of the epoxy in about 5 g of glow powder. The proportion of glow powder (in grams) to the epoxy (ml) may be (0.8-1.2):1.

The method may further comprise the step of applying a plurality of layers of the mixture after the curing step to obtain a glow coat with a predefined thickness.

The viscosity of the epoxy glow coat may range between 10-20 Pa·s. The viscous mixture may be applied directly to an article, or pre-formed from a mould.

### BRIEF DESCRIPTION OF THE DRAWINGS

The invention will now be described with reference to the enclosed drawings, in which:

FIG. 1 is an illustrated drawing of a door and door-frame comprising articles fabricated with the epoxy glow coat according to an embodiment of the present invention;

FIG. 2 is an exemplary perspective view of a helicopter with a rappelling kit comprising articles fabricated with the epoxy glow coat according to an embodiment of the present invention;

FIG. 3 is an exemplary perspective view of the rappelling kit of FIG. 3;

FIGS. 4a, 4b and 4c are respectively the top, perspective and front views of a mould for fabricating a shear pin slot used in the rappelling kit of FIG. 3; and

FIG. 5 shows a flowchart illustrating a method for preparing an epoxy glow coat according to an embodiment of the present invention.

### DETAILED DESCRIPTION OF THE PREFERRED EMBODIMENTS

Example embodiments of the present invention provide a highly viscous epoxy glow coat which can be applied in layers to produce a thick coat e.g. 5 mm. In an embodiment, the viscosity of the epoxy glow coat ranges between about 10-20 Pa·s.

The highly viscous and adhesive nature of the epoxy glow coat according to embodiments of the invention makes it easy to be applied on any article. For instance, the epoxy can be applied on most plastics, metallic surfaces, paper, wood, glass, concrete etc.

Furthermore, the epoxy glow coat can be moulded into an article of any intended shape using e.g. a mould having a non-stick surface, or a smooth surface that can be cut and removed. Release agents (e.g. grease, Teflon, etc) can be applied to the surfaces of the mould before pouring the epoxy glow coat mixture into the mould.

As the epoxy glow coat of example embodiments result in a hard surface after curing, it is also protective in nature, resistant to physical damage, and protective to lubricant, oil, grease, hydraulic fluid, water etc. The protective nature of the epoxy glow coat of example embodiments results in reducing costs for repair, replacement, or reduces down-times (e.g. a rappelling kit) needed for re-application of the glow coats.

Example embodiments of the glow coat can be used or applied to an article at room temperature.

Example embodiments can provide a glow coat with substantially high luminous intensity.

Example embodiments of the glow coat can increase the durability when compared to existing glow coats.

In an embodiment, predefined amounts of a clear epoxy and glow powder are mixed at room temperature for about 10 minutes to obtain a highly viscous glow coat mixture exhibiting advantageous results.

Clear epoxy referred to above may refer to any epoxy which can produce a transparent epoxy layer when cured.

In an embodiment, the glow powder used is commercially known as “SLG-1”. “SLG-1” has a particle size of about 40-50 μm, a glow time of about 18 hours on full charge (about 5 minutes under direct sunlight or about 30 minutes under indoor lamps).

In an embodiment, Devcon 2 Ton Clear Epoxy (2 in 1) may comprise an Epoxide (resin) and polyamide (hardener). In an embodiment, the resin may be Epichlorohydrin and the hardener may be Bisphenol A.

In an embodiment, the glow powder referred to above may be an Alkaline Earth-Metal Aluminate Oxide doped with Europium with a chemical formula MO.Al₂O₃:EU commonly termed as a Photo Luminescent Pigment. MO.Al₂O₃:EU is soluble in water, has a melting point of about 1200° C. and is classified as a non-hazardous material under 29 CFR 1910.

In an embodiment, the glow powder and the epoxy are mixed without using any solvents to obtain the glow coat mixture. In an embodiment, the glow powder and the epoxy can be mixed for about 5-20 minutes to obtain the glow coat mixture.

In an embodiment, a proportion of about 5 ml of the epoxy in about 5 g of glow powder is used for obtaining the glow coat mixture.

In example embodiments, in order to obtain the glow coat mixture, the proportion of glow powder (in grams) to the epoxy (ml) may be about (0.8-1.2):1.

The highly viscous glow coat mixture is then applied to an area e.g. an article or poured in to a mould and cured for about 2 hours to obtain a hardened flow coat. In an embodiment, the time for functional cure is about 2 hours. In practice, the time preferred for a complete cure is about 12 hours. If needed, a plurality of layers can be applied to obtain a desired thickness. e.g. a coating of about 5 mm thickness.

TABLE 1 summarizes a comparative study of the performance of different embodiments of glow materials, Mixture A, Mixture B, Mixture C, as well as existing glow paint and glow tape.

Phosphorescent paint referred here may be a silver activated zinc sulfide, while glow tape referred here may be a polyester laminated photo-luminescent film.

Mixture A corresponds to the above glow coat mixture comprising proportions of about 5 ml of a commercially available Devcon 2 Ton Clear Epoxy (2 in 1) mixed in about 5 g of glow powder for about 10 minutes at room temperature.

Mixture B corresponds to the above Mixture A in which the proportion of the glow powder is 4 g in about 5 ml of the epoxy.

Mixture C corresponds to the above Mixture A in which the proportion of the glow powder is 3 g in about 5 ml of the epoxy.

TABLE 1

| | Type of Glow | Glow Durability | Luminous Intensity |
|---|---|---|---|
| No. | Material | (Minutes) | (Lux) |
| 1 | Mixture A | 75 | 40 |
| 2 | Mixture B | 60 | 32 |
| 3 | Mixture C | 45 | 13 |
| 4 | Glow paint | 5 | 10 |
| 5 | Glow tape | 20 | 16 |

Glow durability refers to the durability of the glow coat/material after being exposed to a table lamp (e.g. having a luminous intensity of about 350-450 lux) for about 5 minutes.

Luminous intensity refers to the intensity of illumination of the glow coat/material after being exposed to a table lamp for about 10 seconds.

It is evident from the above Table 1 that Mixture A and Mixture B provide substantial improvement in glow durability and glow intensity when compared to glow paint, or glow tape.

Also, Mixture C provides substantial improvement in glow durability when compared to glow paint, or glow tape.

Furthermore, the epoxy glow coat or article applied with the epoxy glow coat were completely covered for about 2 hours at room temperature with chemicals, such as a hydraulic fluid (e.g. Aeroshell Fluid 41), a solvent (e.g. Methyl Ethyl Ketone), a grease (e.g. Aeroshell Grease 33) and oil (e.g. Aeroshell W100). The results of the test did not show any degradation of the glow material or its luminance.

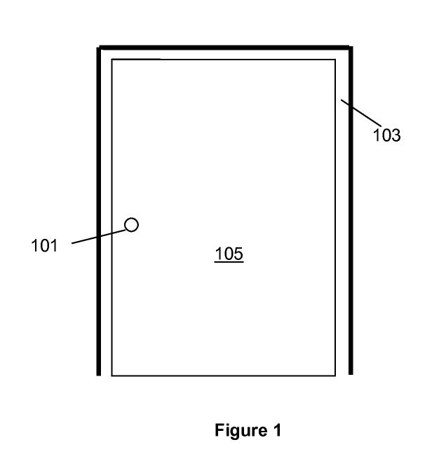

FIG. 1 is an illustrated drawing of a door 105 and a door frame 103. The door-knob 101 may be partly or completely fabricated with the above epoxy glow coat to provide visual cue to the home users. Likewise, part of the door frame 103 could also be coated with above epoxy.

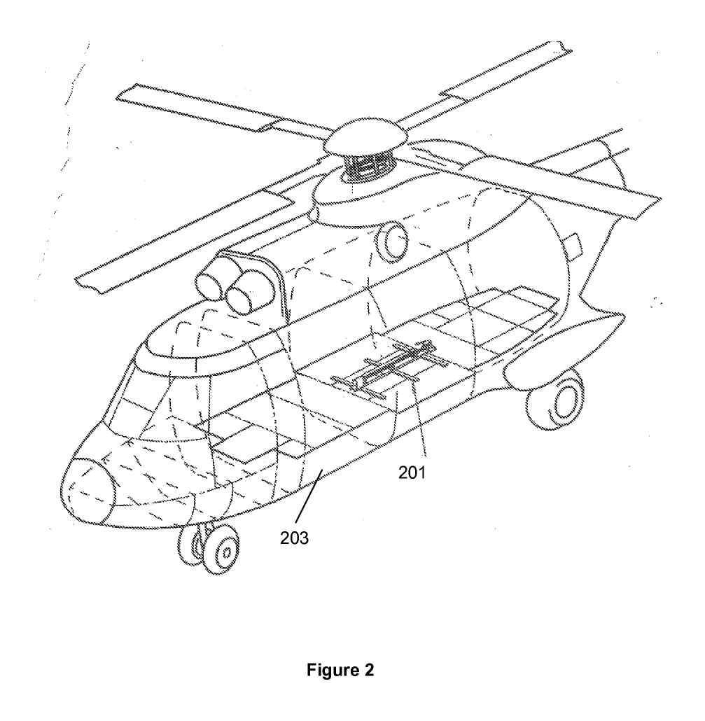

FIG. 2 is an exemplary perspective view of a helicopter 203 with a rappelling kit 201 securely fastened inside the fuselage.

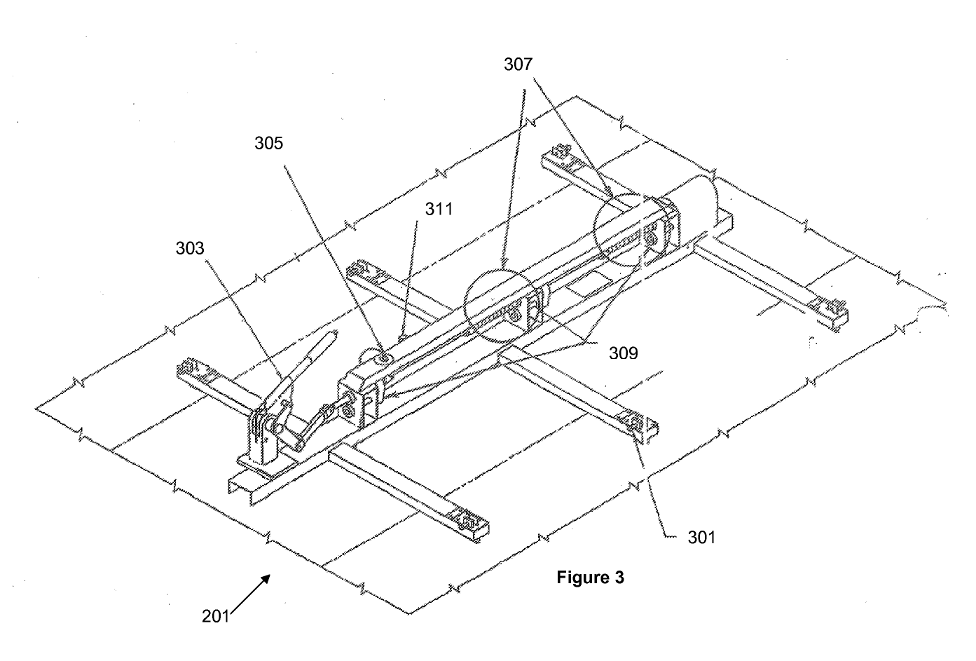

FIG. 3 is an exemplary perspective view of the rappelling kit 201 of FIG. 3. Components of the rappelling kit such as, locking pin 301, handle 303, shear pin 305, rod/return spring 307, attachment point 309 or shear pin holder 311 could be partly or completely fabricated with the above epoxy glow coat in order to provide visual cues to the commandos during night missions.

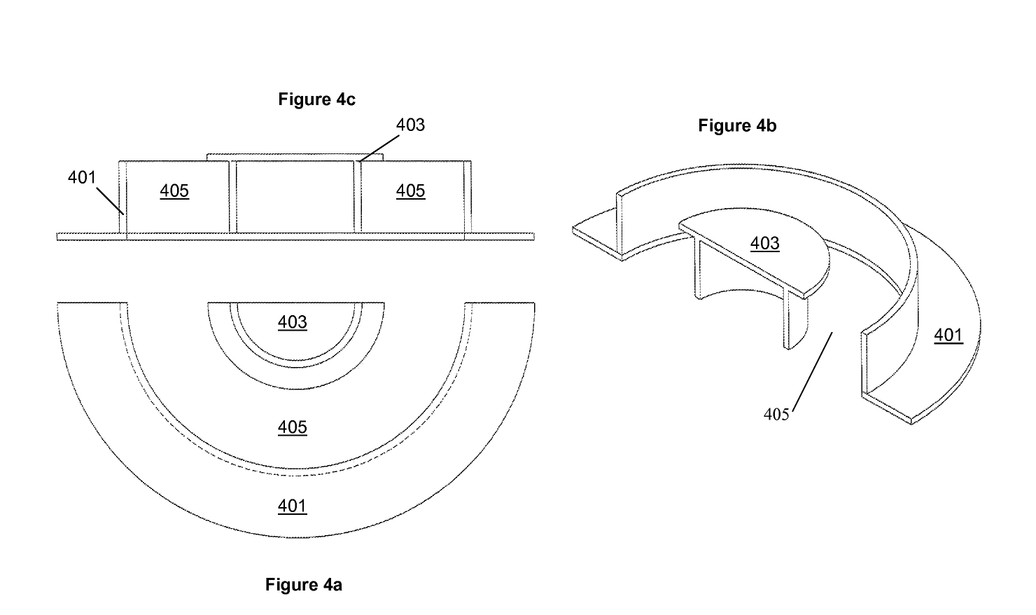

FIGS. 4a, 4b and 4c are respectively the top, perspective and front view of a mould 400 for fabricating a shear pin slot 305 used in the rappelling kit 201 of FIG. 3. The mould 400 consists of a outer portion 401 and an inner portion 403 and a hollow portion 405 in between the outer portion and the inner portion 401. The above glow coat mixture is poured into the hollow portion 405 and cured to obtain the shear pin 305.

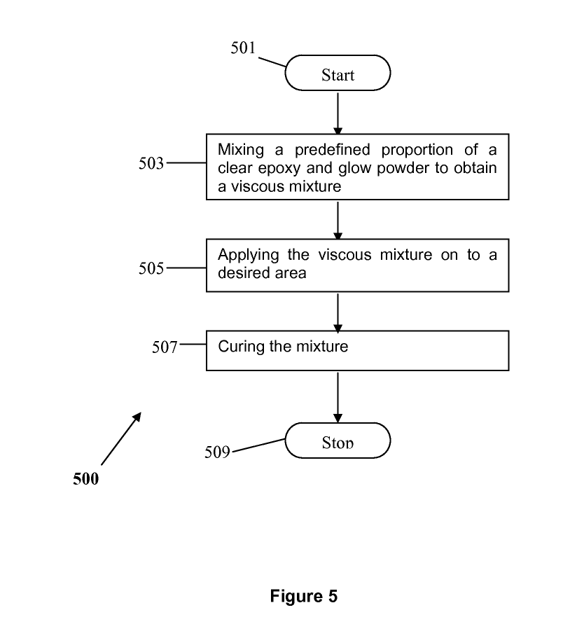

FIG. 5 shows a flowchart 500 illustrating a method for preparing an epoxy glow coat according to an embodiment of the present invention.

At step 501, the method of preparing the glow coat is started. At step 503, a predefined proportion of a clear epoxy and glow powder are mixed to obtain a viscous mixture. At step 505, the viscous mixture is applied to a desired area. At step 507, the mixture is cured. At step 509, the procedure is stopped.

It will be appreciated by a person skilled in the art that numerous variations and/or modifications may be made to the present invention as shown in the specific embodiments without departing from the scope of the invention as broadly described. The present embodiments are, therefore, to be considered in all respects to be illustrative and not restrictive.

1. A method of preparing an epoxy glow coat comprising the steps of:
mixing a predefined proportion of a clear epoxy and glow powder to obtain a viscous mixture;
applying the viscous mixture on to a desired area; and
curing the mixture.

2. The method according to claim 1, wherein the mixture is obtained at room a temperature.

3. The method according to claim 1, wherein the epoxy is Devcon 2 Ton Clear Epoxy (2 in 1).

4. The method according to claim 3, wherein the Devcon 2 Ton Clear Epoxy (2 in 1) epoxy comprises an Epoxide (resin) and polyamide (hardener).

5. The method according to claim 4, wherein the resin is Epichlorohydrin and the hardener is Bisphenol A.

6. The method according to claim 1, wherein the glow powder comprises an Alkaline Earth-Metal Aluminate Oxide doped with Europium and has a chemical formula MO.Al₂O₃:EU.

7. The method according to claim 1, wherein the proportion is about 5 ml of the epoxy in about 5 g of glow powder.

8. The method according to claim 1, wherein the proportion of glow powder (in grams) to the epoxy (ml) is about (0.8-1.2):1.

9. The method according to claim 1, further comprising the step of applying a plurality of layers of the mixture after the curing step to obtain a glow coat with a predefined thickness.

10. The method according to claim 1, wherein the viscosity of the epoxy glow coat ranges between about 10-20 Pa·s.

11. The method according to claim 1, wherein the viscous mixture is applied directly to an article, or pre-formed from a mould.

12. An article comprising an epoxy glow coat prepared in accordance with the method of claim 1.

13. An epoxy glow coat comprising:
a mixture obtained by mixing predefined proportions of a clear epoxy and glow powder.

14. The epoxy glow coat according to claim 13, wherein the mixture is obtained at room temperature.

15. The epoxy glow coat according to claim 13, wherein the epoxy is Devcon 2 Ton Clear Epoxy (2 in 1).

16. The epoxy glow coat according to claim 15, wherein the Devcon 2 Ton Clear Epoxy (2 in 1) epoxy comprises an Epoxide (resin) and polyamide (hardener).

17. The epoxy glow coat according to claim 16, wherein the resin is Epichlorohydrin and the hardener is Bisphenol A.

18. The epoxy glow coat according to claim 13, wherein the glow powder comprises an Alkaline Earth-Metal Aluminate Oxide doped with Europium and has a chemical formula MO.Al₂O₃:EU.

19. The epoxy glow coat according to claim 13, wherein the proportion is about 5 ml of the epoxy in about 5 g of glow powder.

20. The epoxy glow coat according to claim 13, wherein the proportion of glow powder (in grams) to the epoxy (ml) is about (0.8-1.2):1.

21. The epoxy glow coat according to any one of claim 13, wherein the glow coat is obtained by applying a plurality of layers of the mixture to obtain a desired thickness.

22. The epoxy glow coat according to claim 13, wherein the viscosity of the epoxy glow coat ranges between about 10-20 Pa·s.

23. The epoxy glow coat according to claim 13 wherein the glow coat is applied directly to an article, or pre-formed from a mould.
